(19) United States
(12) Patent Application Publication
(10) Pub. No.: US 2007/0049296 A1
(43) Pub. Date: Mar. 1, 2007

(54) Method and device for provisioning content to a plurality of remote devices within a proximity area

(76) Inventors: Sanjay Gupta, Lakewood, IL (US); John D. Bruner, South Barrington, IL (US); Michael D. Kotzin, Buffalo Groves, IL (US)

Correspondence Address: MOTOROLA INC, 600 NORTH US HIGHWAY 45, ROOM AS437, LIBERTYVILLE, IL, 60048-5343, US

(21) Appl. No.: 11/215,261

(22) Filed: Aug. 30, 2005

(51) Int. Cl. H04Q 7/20

(52) U.S. Cl. 455/456.5; 455/414.1

(57) ABSTRACT

A system, method and device for transmitting content from a wireless communication network (102) to a plurality of remote devices (104-116) within a proximity area (126) according to a proximity map (400, 600). The method includes a server (118) bundling content into a first bundle in which the first bundle includes content for delivery to the plurality of remote devices (104-116) and transmitting the first bundle to a first remote device (104) of the plurality of remote devices according to the proximity map (400, 600). Additionally, disclosed is the first remote device (104) transmitting to a second remote device (110) a second bundle including content of the first bundle.

### FIELD OF THE INVENTION

This disclosure in general relates to provisioning of content. More particularly, it relates to the proximity of remote devices and processing content for delivery.

### BACKGROUND

Communication networks are used to transmit information through wires and through radio links. Examples of communication networks include Internet networks, cellular telephone networks and paging networks. Wireless communication networks, in particular, may utilize land lines, radio links and satellite links, and may be used for cellular phone communication, Internet communication, computer network communication, paging communication, satellite systems, and other types of communication. Wireless networks for communication of media are becoming increasingly popular and require increasingly higher capacity. Media information and data are transmitted via wireless networks and are becoming a common part of business and personal activity.

The transfer of digital media data includes transfer of text, audio, graphical, video data, and other related types of data. A user may interactively acquire the data, i.e., by sending commands or requests, such as in Internet navigation, browsing and downloading, or acquire data in a passive manner, such as media data periodically pushed to the subscriber, which is programmed to autonomously receive, present and/or store the media data.

Wireless networks have also brought about a change in devices that communicate the data. A wide variety of handheld wireless devices have been developed along with wireless networks. Such handheld wireless devices include, for example, cellular phones, pagers, radios, personal digital assistants (PDAs), notebook or laptop computers incorporating wireless modems, mobile data terminals, wirelessly enabled gaming devices, etc. These devices may be part of a wireless local area network (WLAN), a wide area network (WAN) or otherwise.

Wireless technology has advanced to include the transfer of high content data. Mobile devices now may include Internet access to receive media content. For example, a communication server may provide media content to various remote devices. For such technologies, point-to-point links are established between the server and each individual remote device. More and more remote devices are equipped with Internet and media access and wireless communication networks and radio channels do not scale easily with the increasing number of remote devices, so the underlying transport resources between servers and remote devices are likely to be subjected to bottlenecks.

### BRIEF DESCRIPTION OF THE DRAWINGS

FIG. 1 is a diagrammatic view of a wireless communication network in communication with a plurality of remote devices in accordance with the present invention.

FIG. 2 is a block diagram illustrating exemplary internal components of a remote device of FIG. 1.

FIG. 3 is a diagrammatic view of a wireless communication system illustrating an exemplary flow of content among nodes or remote devices.

FIG. 4 is a table illustrating a proximity map, in the form of a content matrix, associated with the exemplary flow of content of FIG. 3.

FIG. 5 is a diagrammatic view of a wireless communication system illustrating an exemplary relationship of connectivity among nodes or remote devices.

FIG. 6 is a table illustrating a proximity map, in the form of a connectivity matrix, associated with the exemplary relationship of connectivity of FIG. 5.

FIG. 7 is a flow diagram illustrating an exemplary operation of the wireless communication network of FIG. 1.

FIG. 8 is a flow diagram illustrating an exemplary operation of a remote device of FIG. 1.

FIG. 9 is a flow diagram illustrating another exemplary operation of a remote device of FIG. 1.

### DETAILED DESCRIPTION OF THE PREFERRED EMBODIMENTS

A system, method and device for generating a proximity map of nodes or remote devices in a proximity area, for delivering content to one or more remote devices within the proximity area, and forwarding the content from the receiving remote device(s) to other remote devices within the proximity area. A wireless communication network or at least one remote device constructs proximity maps based on signals received from the remote devices. Each proximity map, described in detail below, may be used to determine the remote devices that are within proximity to each other based on information received directly from remote devices or indirectly via an intermediate device, for example, base stations.

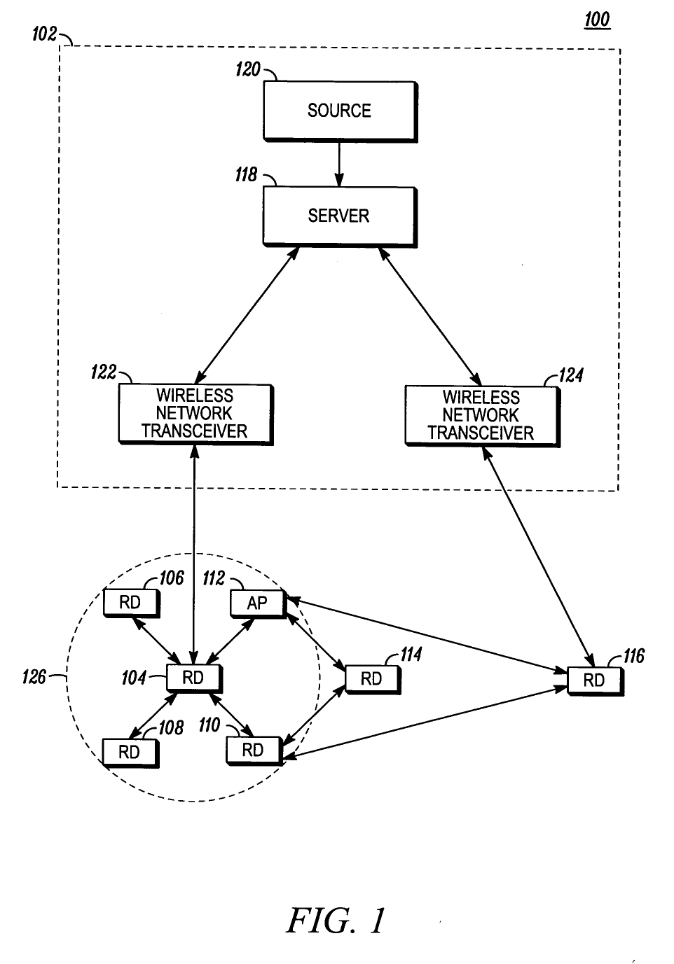

Referring to FIG. 1, the wireless communication system 100 and method described herein include a wireless communication network 102 in communication with a plurality of nodes or remote devices 104-116. The wireless communication network 102 includes one or more servers 118 (such as a media gateway), one or more content sources 120 for providing content to the server or servers, and one or more wireless network transceivers 122, 124 for providing wireless communication between the server or servers and the plurality of remote devices.

The wireless communication system 100 may be any type of system that communicates with a plurality of nodes or remote devices, communicating with one or more remote device via a wireless link. Wireless links utilized by the wireless communication network 102 include, but are not limited to, cellular-based communications such as analog communications (using AMPS), digital communications (using CDMA, TDMA, GSM, iDEN, GPRS, or EDGE), and next generation communications (using UMTS, WCDMA or CDMA2000) and their variants; a peer-to-peer or ad hoc communication technology such as HomeRF, Bluetooth and IEEE 802.11 (a, b or g); and other forms of wireless communication such as infrared technology. Also, the remote devices 104-116 may also communicate with each other via a peer-to-peer or ad hoc communication technology, such as those technologies identified above.

For example, for the wide area network shown in FIG. 1, the server 118 may receive content from the content source or sources 120 and provide the content, and related information, to the wireless network transceivers 122, 124. Each server 118 may have a variety of content handling functions, such as receiving requests for content from the remote devices, processing content preparation and content transmission, and receiving and processing signals relating to the proximity of remote devices. Each wireless network transceiver 122, 124 may communicate, directly or indirectly, with the server 118 and singularly or together define the proximity area 126 of the proximity map. Each content source 120 provides media content to the media gateway and may either be controlled by a service provide managing the wireless communication network 102 or an external entity communicating with the wireless communication network. In general, the wireless communication network 101, including any parts thereof, may perform all functions as described herein that are not performed by the remote devices 104-116.

The remote devices 104-116 may subscribe to content and communicate their needs to have the content updated, implicitly or explicitly. Alternatively, the wireless communication network 102 or, more particularly, the server 118 in communication with the remote devices may predict whether to update content according to past request history, usage or subscription data. A correct prediction may forestall a request from a remote device, and reduce network traffic and/or load on the server.

One or more of the remote devices 104-116 are capable forwarding content destined for other remote devices. In other words, a first remote device 104 located within the proximity area 126 may receive content on behalf of a second remote device 106 located within the proximity area. The first remote device 104 may then forward the content to the second remote device 106. The content, received by the first remote device 104 but destined for other remote devices 106-112 within the proximity area 126, may be encrypted for security. Accordingly, for some embodiments, the first remote device 104 would not be able to access the content it is forwarding to another remote device 106-112.

For another embodiment, a given remote device may follow predetermined routing considerations based on the type of content received or party from which content is received. Special or expedited care may be provided to high priority content or content received from an important source. A remote device may also refuse to forward content having a controversial nature or content received from a controversial source. For example, a remote device may refuse to forward controversial content or content received from a controversial source to handsets owned by minors.

The content may be formatted to facilitate extraction of the content of interest and to conserve resources (battery, processing and memory) of a remote device. For example, information relating to identifiers of content and pointers to their location may be provided. The identifier and pointer information may be sent, for example, as a separate data packet from the content or as a header of the content itself, which may be parsed in real time.

The server 118 or other parts of the wireless communication network 102 may maintain a database of content, subscriptions of remote devices, and their associated attributes. The server 118 may receive content feeds from the content providers or sources 120 for each grouping of content supported by it. The server 118 may determine the needs of the remote devices 104-116. Based on the needs and the proximity map, the wireless communication network 102 or, more particularly, the server 118, such as a media gateway, may package the media content into primary bundles intended for a plurality of remote devices 104-112 within the proximity area 126. The primary bundles from the server 118 are then forwarded to one or more remote devices 104-112 via appropriate transport channels, such as the wireless links described above. A first remote device 104 can, therefore, receive content not intended for it, but send that content to a second remote device 106-112 within the proximity area 126.

For the embodiment shown in FIG. 1, a certain subset of the remote devices 106-112 may be within proximity of each other, within a proximity area 126. It is to be understood that other remote devices, such as remote devices 114 and 116, may be outside of the proximity area 126, may or may not be within a different proximity area, and/or capable of communicating with another wireless network transceiver 124. Also, each remote device 104-116 may be in one proximity area or multiple proximity areas. Further, the remote devices 104-116 may include mobile devices 104-110, 114, 116 and/or stationary access points 112.

This description is provided to further explain in an enabling fashion the best modes of making and using various embodiments in accordance with the present invention. The description is further offered to enhance an understanding and appreciation for the invention principles and advantages thereof, rather than to limit in any manner the invention. The invention is defined solely by the appended claims including any amendments of this application and all equivalents of those claims as issued.

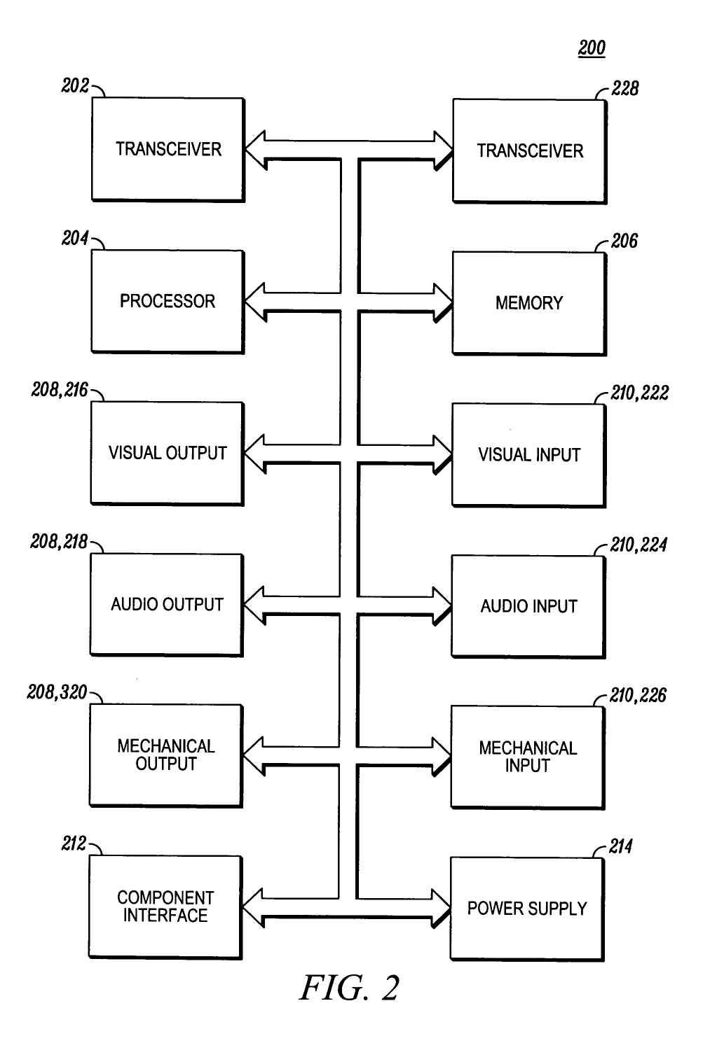

Referring to FIG. 2, there is provided a block diagram illustrating exemplary internal components 200 of a node or remote device 104-116. The exemplary internal components 200 includes one or more wireless transceivers 202, 228, a processor 204, a memory portion 206, one or more output devices 208, and one or more input devices 210. Each embodiment may include a user interface that comprises one or more output devices 208 and one or more input device 210. Each transceiver 202 may utilize wireless technology for communication, such as the wireless communication links or connections described above. The internal components 200 may further include a component interface 212 to provide a direct connection to auxiliary components or accessories for additional or enhanced functionality. The internal components 200 preferably include a power supply 214, such as a battery, for providing power to the other internal components while enabling the mobile device 102 to be portable.

An exemplary function of the wireless communication device 102 as represented by the internal components 200, upon reception of wireless signals, the internal components detect communication signals and the transceiver 202, 228 demodulates the communication signals to recover incoming information, such as voice and/or data, transmitted by the wireless signals. After receiving the incoming information from the transceiver 202, 228, the processor 204 formats the incoming information for one or more output devices 208. Likewise, for transmission of wireless signals, the processor 204 formats outgoing information, which may or may not be activated by the input devices 210, and conveys the outgoing information to the transceiver 202, 228 for modulation to communication signals. The transceiver 202, 228 conveys the modulated signals to a remote device, such as servers 104, 106, 108, 124. It is to be noted that the transceiver or transceivers 202, 228 may utilize any type of wireless communication technology as described above. For example, each transceiver of a remote device may operate at a different frequency or utilize a different technology so that the device may have multiple ways of communicating with a wireless network transceiver 122, 124 or other remote devices 104-116.

The input and output devices 208, 210 of the internal components 200 may include a variety of visual, audio and/or mechanical outputs. For example, the output device(s) 208 may include a visual output device 216 such as a liquid crystal display and light emitting diode indicator, an audio output device 218 such as a speaker, alarm and/or buzzer, and/or a mechanical output device 220 such as a vibrating mechanism. Likewise, by example, the input devices 210 may include a visual input device 222 such as an optical sensor (for example, a camera), an audio input device 224 such as a microphone, and a mechanical input device 226 such as a flip sensor, keyboard, keypad, selection button, touch pad, touch screen, capacitive sensor, motion sensor, and switch. Actions that may actuate one or more input devices 210 include, but not limited to, opening the wireless communication device, unlocking the device, moving the device to actuate a motion, moving the device to actuate a location positioning system, and operating the device.

The memory portion 206 of the internal components 200 may be used by the processor 204 to store and retrieve data. The data that may be stored by the memory portion 206 include, but is not limited to, operating systems, applications, media content and other data. As described herein, each mobile device 104-116 receives content its own designated content and may receive content designed for other devices. All types of content may be store temporarily or longer in the memory portion 206 of a remote device 104-116.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

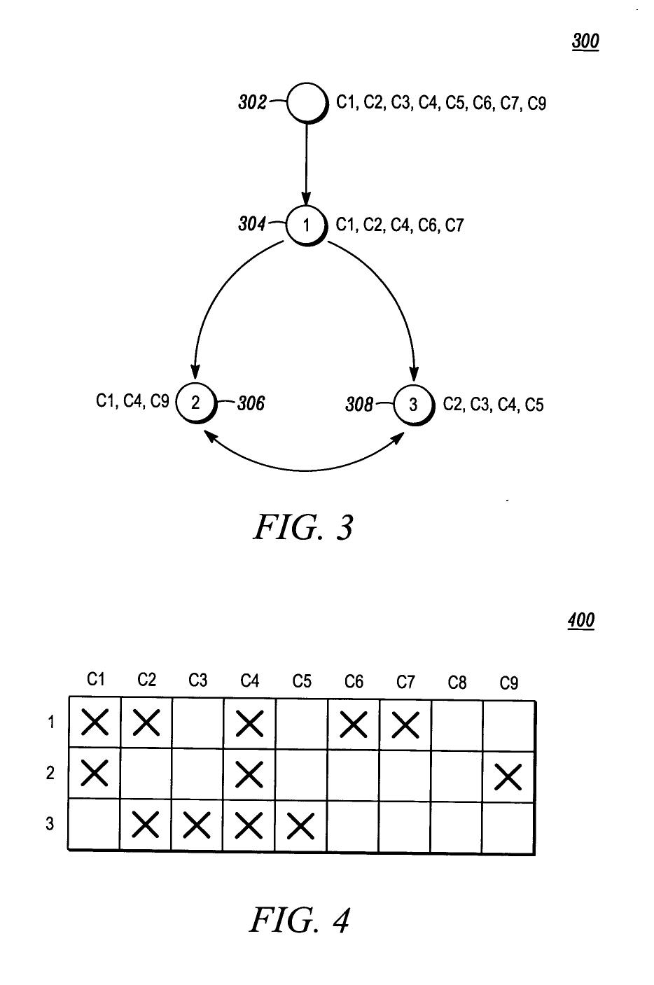

Referring to FIG. 3, there is shown a wireless communication system 300 illustrating an exemplary flow of content from a wireless communication network 302 to a plurality of nodes or remote devices 304, 306, 308. For this embodiment, the wireless communication network 302 identifies all content that may or should be delivered to the remote devices 304, 306, 308. Remote device 304 may or should receive content C1, C2, C4, C6 and C7; remote device 306 may or should receive content C1, C4 and C9; and remote device 308 may or should receive C2, C3, C4 and C5. Thus, the wireless communication network 302 sends all content that is to be delivered, to one or more of the remote devices 304, 306, 308 and these receiving remotes units may forward some or all of the content to the remaining remote devices.

The wireless communication network 302 may determine that remote device 304 is the “best” remote device to receive a primary bundle of content for distribution of secondary bundles of content to other remote devices 306, 308. The wireless communication network 302 may identify the “best” remote device or units based on one or more factors including, but not limited to, the location of the remote devices relative to one or more wireless network transceivers 122, 124, the location of the remote devices relative to each other, the signal strength or other signal characteristics of the remote devices detected by the network, the type or quantity of content to be received by each remote device, the memory capacity of each remote device, the energy (such as battery power) available to each remote device, and other transmission and processing capabilities of the remote devices.

The wireless communication network 302 would collect information about one or more of these factors via proximity maps generated by the network and/or received from the remote devices 304, 306, 308. The primary bundle or bundles of content would include all content to be delivered to the various remote devices 304, 306, 308. It is conceivable that the primary bundle or bundles may also include addition content that is not destined for any of the remote devices within a proximity area 126. The secondary bundle or bundles of content may include the same content as the primary bundle(s) or less, and may not include more content than the content of the primary bundle. It should be noted that secondary bundles may or may not include non-content information that is not included in the primary bundle(s).

For example, as illustrated in FIG. 3, the wireless communication network 302 create a primary bundle of content that includes C1 through C7 and C9 and provide this primary bundle to a first remote device 304. As described above, the primary bundle may also include additional content (such as C8) although not necessary, and the first remote device 304 may have been chosen to receive the primary bundle based on one or more factors. The first remote device 304 may extract content designated to it, such as C1, C2, C4, C6 and C7, use by the first remote device. The first remote device 304 may also forward all content of the primary bundle or send a portion of the primary bundle to second and third remote devices 306, 308.

For one embodiment, the first remote device may send a secondary bundle, which includes all contents of the primary bundle, to the second remote device 306 and the third remote device 308. For another embodiment, the first remote device may send a secondary bundle, which includes a portion of the primary bundle such as C1, C4 and C9, to the second remote device 306 and another secondary bundle, which includes a different portion of the primary bundle as C2-C5, to the third remote device 308. For yet other embodiments, the first remote device may send a secondary bundle, which includes all contents or part of the contents of the primary bundle, to the second remote device 306 and, in turn, the second remote device may send a tertiary bundle to the third remote device 308. Of course, the secondary bundle may be sent to the third remote device 308, and the tertiary bundle may be sent from the third remote device to the second remote device 306.

Referring to FIG. 4, there is provided a table 400 illustrating one type of proximity map, in the form of a content matrix, associated with the exemplary flow of content of FIG. 3. Various types of proximity maps may be utilized for the present invention including, but not limited to, tables representing the location of the remote devices relative to each other, the signal strength or other signal characteristics of the remote devices detected by the network, the type or quantity of content to be received by each remote device, the memory capacity of each remote device, the energy (such as battery power) available to each remote device, and other transmission and processing capabilities of the remote devices. For this embodiment, illustrated by FIG. 4, the proximity map may be a content matrix representing the content to be received by each remote device. For example, the first node or remote device 304 may or should receive content C1, C2, C4, C6 and C7, the second node or remote device 306 may or should receive content C1, C4 and C9, and the third node or remote device 308 may or should receive content C2, C3, C4 and C5. For this example, C8 is the only content that is not needed or desired by any of the nodes or remote devices. Therefore, the wireless communication network 302 may provide all content except C8 to the first remote device 304 and, thereafter, the second and third remote devices 306, 308 may receive their respective content from the first remote device.

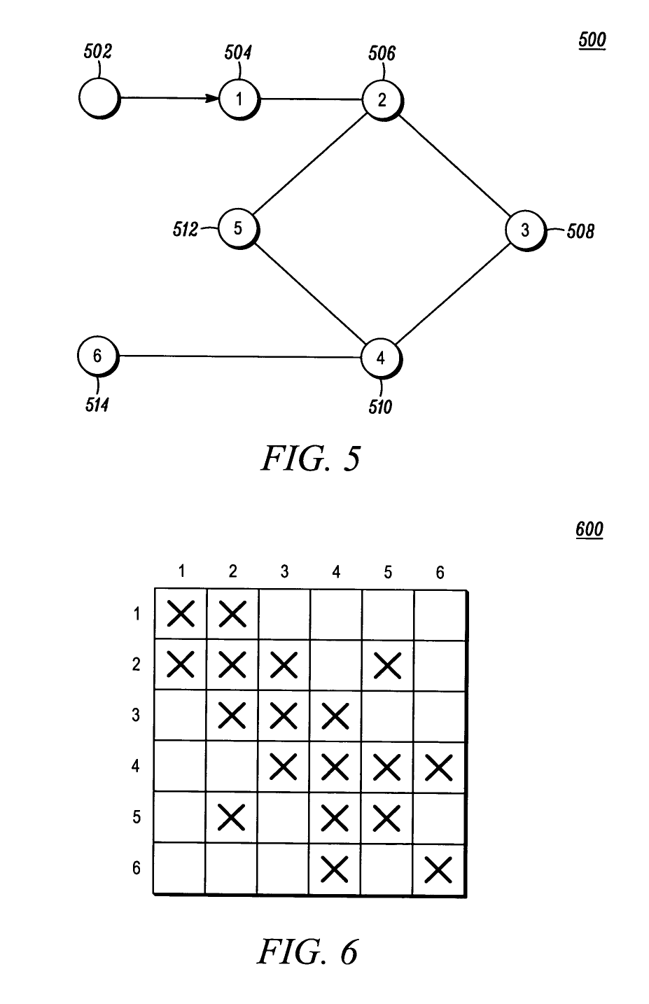

Referring to FIG. 5, there is provided a diagrammatic view of a wireless communication system 500 illustrating an exemplary relationship of connectivity among nodes or remote devices. FIG. 5 is similar to FIG. 3, but is directed to the relationship of the nodes or remote devices relative to each other instead of the content. For this embodiment, the wireless communication network identifies all possible communication links among the remote devices 504-514. The different communication links available to each remote device may depend upon the distance between remote devices, interference experienced between remote devices, the range of one or more common technology used to communicate between remote devices, and/or other factors that may affect signal strength between remote devices.

For example, as shown in FIG. 5, the wireless communication network 502 may have only one acceptable communication link with all nodes or remote devices 504-514, such as the communication link to the first remote device 504, at a given time. Of course, as one or more of the remote devices move, these connectivity relationships may change. The first remote device 504, for example, may similarly have only one acceptable communication link with the other remote devices, such as the communication link to the second remote device 506. The second remote device 506, however, has acceptable communication links to more than one remote device other than the first remote device 504, such as the third remote device 508 and the fifth remote device 512. The third and fifth remote devices 508, 512, in turn, have acceptable communication links to the fourth remote device 510, and the fourth remote device has an acceptable communication link with the sixth remote device 514. The wireless communication network 502 would collect the above information via proximity maps generated by the network and/or received from the remote devices 504-514.

Continuing with the above example, assuming that the wireless communication network 502 plans to communicate content to the first remote device 504, the first remote device has only one option for passing along one or more content to the other remote devices, i.e., the first remote device would provide content destined for the other remote devices to the second remote device 506. The second remote device 506, however, as more than one option for providing content received from the first remote device 504 to other remote device, i.e., via the third remote device 508 and/or the fifth remote device 512. For some embodiments, when providing content from the second remote device 506 to the third remote device 508, content may be provided directly to the third remote device or indirectly via the fifth and fourth remote devices 512, 510. Likewise, when providing content from the second remote device 506 to the fifth remote device 512, content may be provided directly to the fifth remote device or indirectly via the third and fourth remote devices 508, 510. The fourth remote device 510 may receive content from either the third remote device 508 or the fifth remote device 512, and the sixth remote device 514, in turn, may receive content from the fourth remote device.

Similar to the other embodiments, the wireless communication network 502 may identify the “best” route for passing content, for example via the third remote device 508 vs. the fifth remote device 512, based on one or more factors including, but not limited to, the location of the remote devices relative to one or more wireless network transceivers, the location of the remote devices relative to each other, the signal strength or other signal characteristics of the remote devices detected by the network, the type or quantity of content to be received by each remote device, the memory capacity of each remote device, the energy (such as battery power) available to each remote device, and other transmission and processing capabilities of the remote devices.

FIG. 6 is a table 600 illustrating a proximity map, in the form of a connectivity matrix, associated with the exemplary relationship of connectivity of FIG. 5. For the embodiment illustrated by FIG. 5, the proximity map may be a connectivity matrix representing the available communication links among the remote devices 504-514. For example, starting with the first row of the table, the first remote device 504 may access its own content as well as communicate content with the second remote device 506. Going down to the next row of the table, the second remote device 506 may communicate content with the first remote device 504, have access to its own content, and communicate content with the third and fifth remote devices 508, 512. The third remote device 508 may communicate content with the second remote device 506, have access to its own content, and communication content with the fourth remote device 510. The fourth remote device 510 may communicate content with the third remote device 508, have access to its own content, and communication content with the fifth and sixth remote devices 512, 514. The fifth remote device 512 may communicate content with the second and fourth remote devices 506, 510, and have access to its own content. Going down to the last row of the table, the sixth remote device 514 may communicate content with the fourth remote device 510, and have access to its own content. Thus, the wireless communication network 502 may provide content destined for all remote devices 504-514 to the first remote device 504 and, thereafter, the other remote devices may receive their respective content, by one path or another, based on the connectivity matrix and other factors described above.

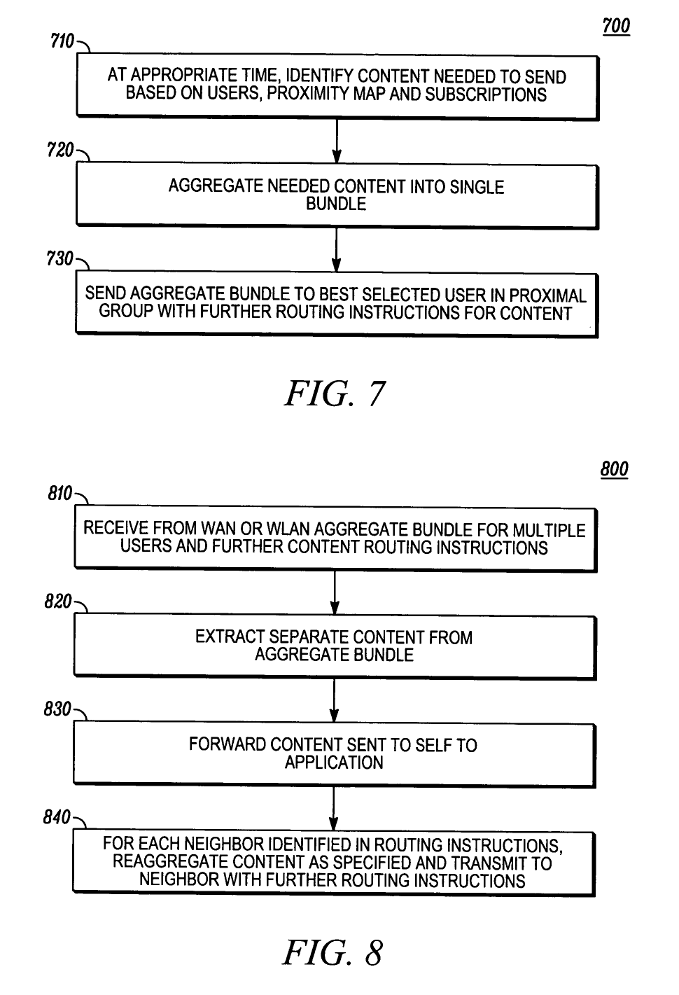

Referring to FIG. 7, there is provided a flow diagram illustrating an exemplary operation 700 of the wireless communication network 102 or, more particularly, one or more servers 118 of the network. The wireless communication network 102 identifies content, or bundles of content, that may or should be sent to various nodes or remote devices based on selected users and their associated proximity maps and/or subscription information at step 710. The content, or bundles of content, may be provided at appropriate times based on the subscriptions of the selected users. The wireless communication network 102 then determines whether content destined for more than one remote device may be aggregated into a single bundle based on the proximity maps associated with the selected users. If there are one or more opportunities to bundle content destined for multiple remote devices into a bundle or bundles, then the wireless communication network 102 proceeds with the aggregation at step 720. Thereafter, the wireless communication network 102 sends the aggregate bundle or bundles to the “best” selected user in a proximal group, i.e., group of remote devices with a single proximity area 126, along with further routing instructions for the content, which, among other things, identifies each node or remote device that shall receive content. As explained above, the “best” selected user and the routing instructions may be determined by the wireless communication network 102 based on the proximity maps associated with the selected remote devices.

Referring to FIG. 8, there is provided a flow diagram illustrating an exemplary operation 800 of a remote device for forwarding content to another remote device. The remote device receives one or more aggregate bundles of content, destined for multiple users, as well as further routing instructions from the wireless communication network 102 at step 810. The aggregate bundle of content may be received from any type of wireless communication network, such as a wide area network (“WAN”) and/or a wireless local area network (“WLAN”). The remote device then extracts separate content from the aggregate bundle at step 820. For one embodiment, the remote device may merely extract content destined to itself so that the bundle may include content for other remote devices but not for the instant remote device. For another embodiment, the remote device may extra all content from the aggregate bundle so that the content is effectively de-bundled. Next, the remote device may forward the content destined to itself to one or more applications of the remote device that may utilize the content at step 830. For example, the content may be stored in a memory portion 206, processed by a processor 204, provided to a user of the remote device via a user interface 208, and/or provided to an auxiliary device connected to the remote device's component interface 212. Thereafter, content destined for other remote devices are transmitted to a neighboring remote device within the proximity area 126 based on the further routing instructions, which identifies each node or remote device that shall receive content, at step 840. If necessary, the content may be reaggregated, with or without the content destined for the instant remote device, before transmitting to the neighboring remote device. Also, the content may be reaggregated into a bundle for each remote device that will receive content from the instant remote device.

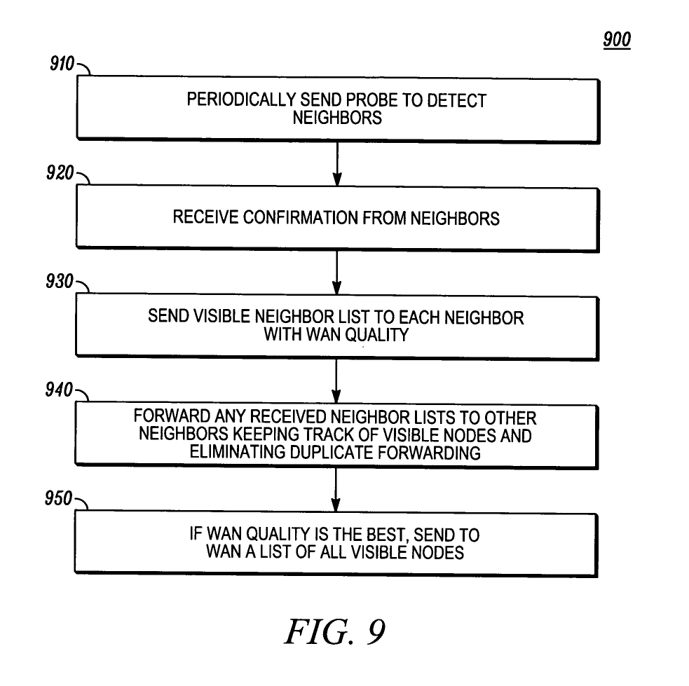

Referring to FIG. 9, there is provided is a flow diagram illustrating another exemplary operation 900 of a remote device for generating and/or updating a proximity map. As described above, proximity maps may be generated by the wireless communication network, one or more of the remote devices or other means. The operation 900 shown in FIG. 9 exemplifies generation of a proximity map at least in part by one or more remote devices.

Each remote device 104-116 may periodically send a probe, such as transmitting one or more wireless communication signals, for neighboring remote device within its proximity area 126 at step 910. Each remote device 104-116 may then receive one or more confirmations in response to the probe from neighboring remote devices at step 920. Next, each remote device 104-116 may send a neighbor list to each neighbor within its proximity area 126 at step 930. For example, a remote device may send a visible neighbor list, i.e., a list of neighbors in which acceptable communication exists, to each neighbor having quality of communication above a particular threshold level, such as WAN quality. Thereafter, each remote device 104-116 may forward any received neighbor lists to other neighbors within its proximity area 126 that track visible nodes or remote devices at step 940. Each remote device 104-116 may also eliminate forwarding of duplicate neighbor lists. Finally, the remote device having the best communication with the wireless communication network 102 sends a list of all visible nodes to the wireless communication network at step 950.

Since remote devices may be mobile stations, their locations may change. A certain remote device may be in a particular wireless network transceiver, i.e., base station, and, hence, in communication with a particular base station and then, moments later, the remote device may be in communication with a different cellular tower. At any given moment, a proximity map of the remote devices in communication with a particular base station may be constructed from received location information. Communication between the remote device and the base station may be sufficient to establish a remote device's location.

For updating the proximity map, timed intervals for generating a proximity map may be, for example, once per minute. Therefore, a proximity map including the remote devices within a certain area in communication with a base station may be generated, for example, as a function of time. Alternatively or in addition, other methods of tracking the remote devices may be used, such as GPS. Additionally, wireless LAN or Bluetooth may provide de facto location information which can be maintained by a remote device and sent to the central unit 101. In the event that a remote device and one or more servers may maintain proximity maps, there is not a requirement for alignment as will be discussed below.

It is also understood that a proximity map may be constructed by one or more remote devices. To reduce the burden on the servers or other parts of the wireless communication network, remote devices may be configured to construct proximity maps as well. Information received from a plurality of remote devices proximate to one another may, in a preliminary manner, in varying degrees or in the same manner as the central unit, provide information sufficient to construct one or more proximity maps. A proximity map constructed by a remote device may be communicated to the central units and/or other remote devices.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method of a central unit for transmitting content to a plurality of remote devices within a proximity area, comprising:
receiving location information from each of the plurality of remote devices;
generating a proximity map of the plurality of remote devices within the proximity area based on receiving the location information from each of the plurality of remote devices; and
bundling content for delivery to the plurality of remote devices into a primary bundle based on the proximity map.

2. The method as recited in claim 1, further comprising:
transmitting the primary bundle to a first remote device within the proximity area of the proximity map.

3. The method as recited in claim 2, further comprising:
transmitting, from the first remote device to a second remote device of the plurality of remote devices a secondary bundle comprising content of the primary bundle.

4. The method as recited in claim 2, further comprising:
sorting, at the first remote device, the primary bundle into more than one bundle.

5. The method as recited in claim 1, wherein the remote devices are cellular devices.

6. A method of a central unit for transmitting content to a plurality of remote devices, comprising:
bundling content into a primary bundle, the primary bundle including content for delivery to the plurality of remote devices; and
transmitting the primary bundle to a first remote device of the plurality of remote devices.

7. The method as recited in claim 6, further comprising:
transmitting, from the first remote device to a second remote device of the plurality of remote devices a secondary bundle comprising content containers of the primary bundle.

8. The method as recited in claim 6, further comprising:
sorting, at the first remote device, the primary bundle into more than one bundle.

9. The method as recited in claim 6, further comprising:
receiving location information from each of the plurality of remote devices;
generating a proximity map of the plurality of remote devices within the proximity area based on the receiving the location information from each of the plurality of remote devices; and
communicating the proximity map to the first remote device.

10. The method of claim 6, wherein the first remote device is a cellular device.

11. An electronic device comprising:
a receiver capable of receiving a primary content bundle;
a processor capable of sorting the primary content bundle into at least one secondary content bundle; and
a transmitter capable of transmitting to a second electronic device a secondary content bundle.

12. The electronic device as recited in claim 11, wherein the transmitter is capable of transmitting a signal relating to the location of the electronic device to a central unit.

13. The electronic device as recited in claim 12, wherein the receiver is capable of receiving a proximity map generated by the central unit indicating electronic devices within a proximity area, and further comprising:
a memory capable of storing the proximity map.

14. The electronic device as recited in claim 11 wherein the electronic device is a cellular telephone.

15. An electronic device, comprising:
a receiver capable of receiving signals related to the proximity of a plurality of electronic devices;
a processor capable of constructing a proximity map based on the signals received relating to the proximity of the plurality of electronic devices; and
a transmitter capable of transmitting the proximity map to a central unit.

16. The electronic device as recited in claim 15, further comprising:
a receiver capable of receiving from the central unit a primary content bundle of containers for delivery to more than one electronic device based on the proximity map.

17. The electronic device as recited in claim 16, further comprising:
a processor capable of sorting the primary content bundle into at least one secondary content bundle; and
a transmitter capable of transmitting to a second electronic device a secondary content bundle.

18. The electronic device as recited in claim 15, wherein the electronic device is a cellular telephone.
